(19) United States
(12) Patent Application Publication
(10) Pub. No.: US 2026/0336513 A1
(43) Pub. Date: Oct. 29, 2026

(54) Turn Signal Assembly

(71) Applicant: La Donnrick Johnson, Long Beach, CA (US)

(72) Inventor: La Donnrick Johnson, Long Beach, CA (US)

(21) Appl. No.: 19/186,806

(22) Filed: Apr. 23, 2025

(51) Int. Cl. B60Q 1/34; B60Q 1/38; B60Q 1/44; B60Q 1/50

(52) U.S. Cl. CPC B60Q 1/343; B60Q 1/38; B60Q 1/44; B60Q 1/503

(57) ABSTRACT

A turn signal assembly for indicating a driver's intent to make a U-turn includes a vehicle including a left taillight and a right taillight positioned on a rear end. A lever is manipulatable to selectively actuate a blinking pattern for one of the left taillight and the right taillight wherein the blinking pattern is designed to signal an intent of a user of the vehicle to turn in a respective one of a left direction and a right direction. A processor is in communication with the lever wherein to selectively actuates the blinking pattern for one of the left taillight and the right taillight when the lever is manipulated. An indicium is coupled to the left taillight. The indicium is designed for illumination within the left taillight to visibly notify a driver who is following the vehicle that the user intends to make a U-turn.

### (b) CROSS-REFERENCE TO RELATED APPLICATIONS

Not Applicable.

### (c) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable.

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to turn signals and more particularly pertains to a new turn signal for indicating a driver's intent to make a U-turn.

### (2) Description of Related Art Including Information Disclosed Under 37 CFR 1.97 and 1.98

The prior art relates to turn signals. Turn signals are an essential safety feature in vehicles, designed to communicate a driver's intent to turn or change lanes. These signals, commonly known as indicators or blinkers, are electrically operated lights that flash in a specific pattern to alert other road users of an impending maneuver. In most modern vehicles, turn signals are activated via a lever located on the steering column, which engages a relay or electronic module to blink the lights at a standardized rate. The widespread adoption of turn signals has significantly improved road safety by reducing the likelihood of collisions caused by sudden or unexpected lane changes and turns.

Despite their effectiveness, conventional turn signal systems have limitations. Drivers may forget to activate their turn signals, fail to turn them off after completing a maneuver, or misuse them in a way that creates confusion for other motorists. One significant limitation is that turn signals can not be used to alert other road users of specific maneuvers, such as making a U-turn instead of a standard left turn. Thus, there is a need for devices which can improve turn signal functionality by providing drivers with the ability to signal their intent to make a U-turn in a different way than the driver signals their intent to make a standard left turn.

### (h) BRIEF SUMMARY OF THE INVENTION

An embodiment of the disclosure meets the needs presented above by generally comprising a vehicle including a left taillight and a right taillight. A rear end faces backwardly from the vehicle relative to a user. Each of the left taillight and the right taillight is positioned on the rear end of the vehicle wherein each of the left taillight and the right taillight are designed to be visible to a driver who is following behind the vehicle. A lever is manipulatable to selectively actuate a blinking pattern for one of the left taillight and the right taillight wherein the blinking pattern is designed to signal an intent of a user of the vehicle to turn in a respective one of a left direction and a right direction.

A processor is in communication with the lever wherein the processor selectively actuates the blinking pattern for one of the left taillight and the right taillight when the lever is manipulated. An indicium is coupled to the left taillight. The indicium is positioned within the left taillight. The indicium is designed for illumination within the left taillight to visibly notify the driver who is following behind the vehicle that the user intends to make a U-turn. The indicium is selected from a group consisting of a broken line, a solid line, and a wording. A toggle is in communication with the processor of the vehicle wherein manipulation of the toggle signals the processor to illuminate the indicium within the left taillight.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear view of a turn signal assembly according to an embodiment of the disclosure.

FIG. 2 is a front view of an embodiment of the disclosure.

FIG. 3 is an in-use view of an embodiment of the disclosure.

FIG. 4 is an in-use view of an embodiment of the disclosure.

FIG. 5 is an in-use view of an embodiment of the disclosure.

FIG. 6 is a block diagram view of an embodiment of the disclosure.

### (j) DETAILED DESCRIPTION OF THE INVENTION

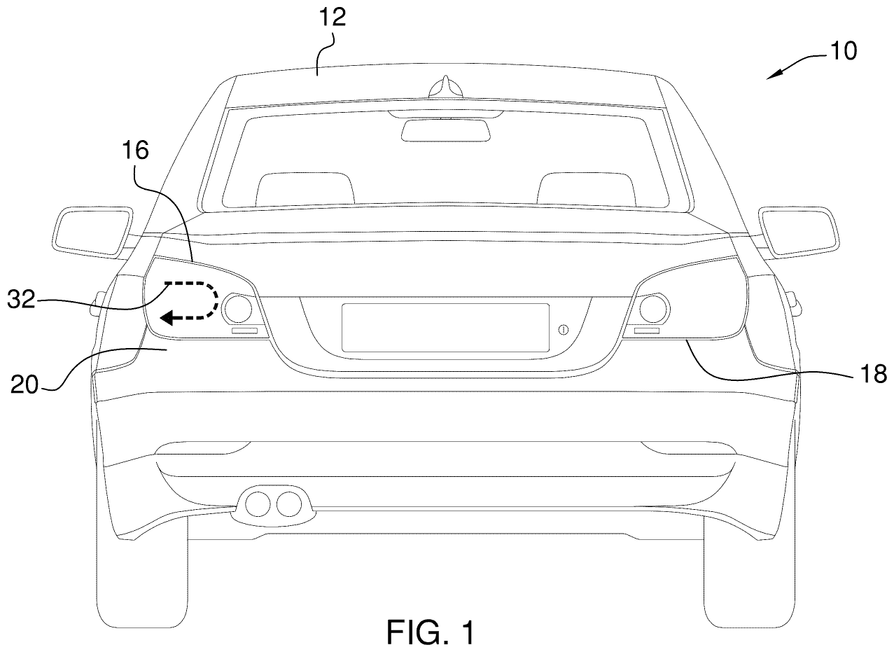

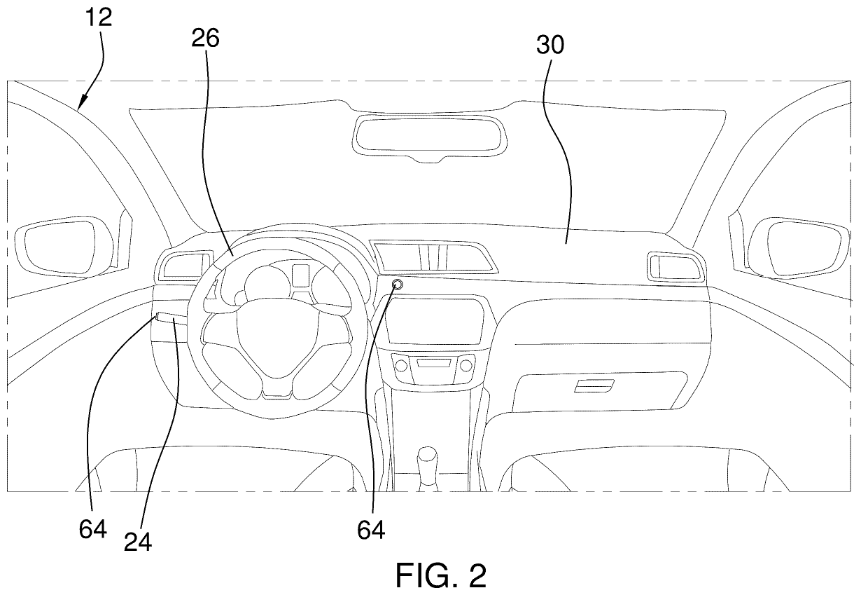

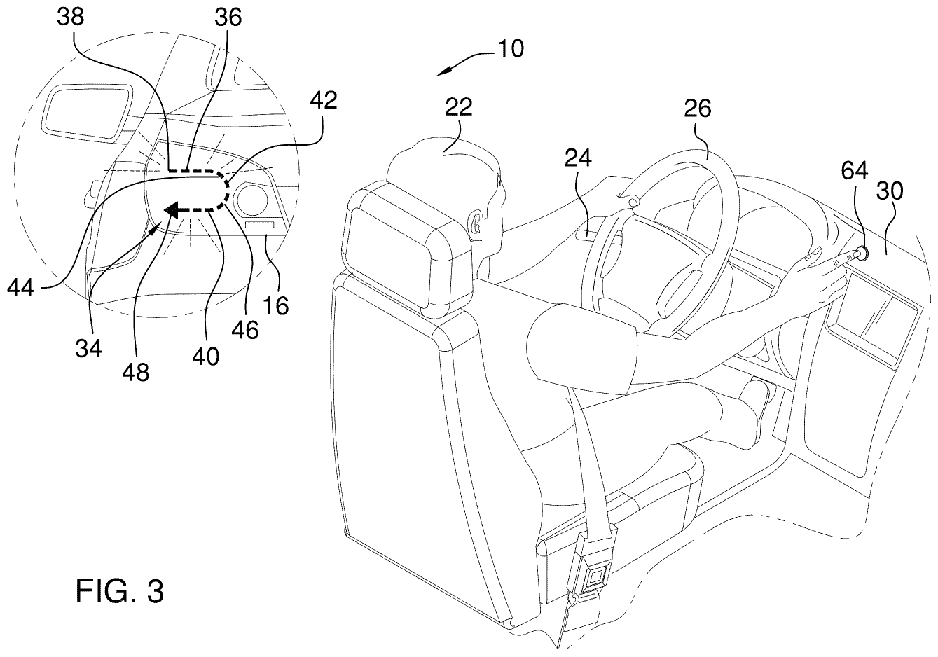

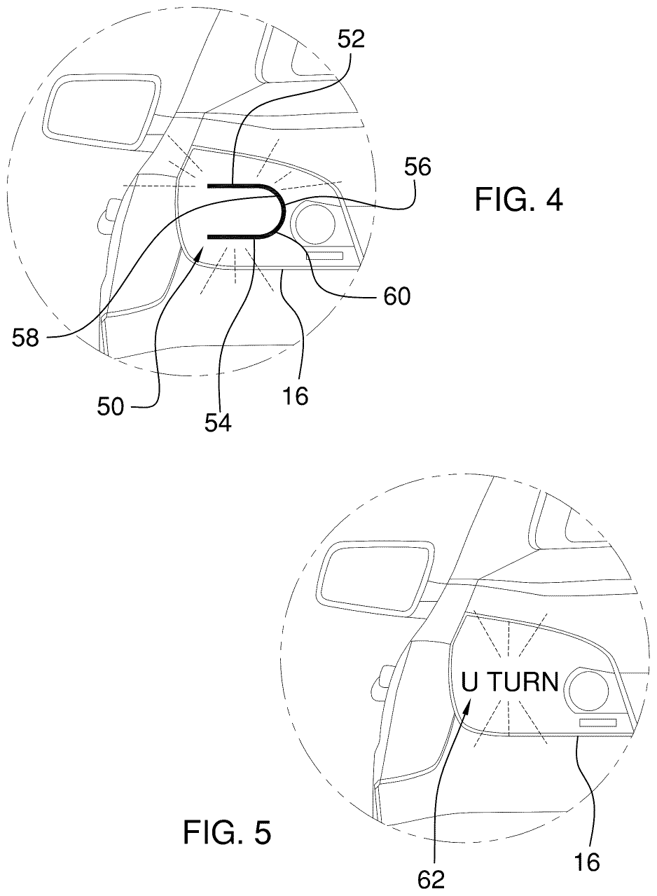

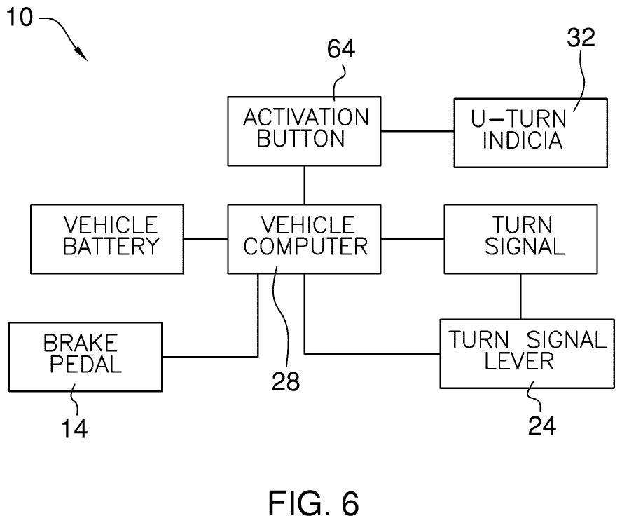

With reference now to the drawings, and in particular to FIGS. 1 through 6 thereof, a new turn signal embodying the principles and concepts of an embodiment of the disclosure and generally designated by the reference numeral 10 will be described.

As best illustrated in FIGS. 1 through 6, the turn signal assembly 10 generally comprises a vehicle 12, which generally includes a brake 14 that is actuatable to stop the vehicle 12. A left taillight 16 is typically illuminated when the brake 14 is actuated. A right taillight 18 is also typically illuminated when the brake 14 is actuated. A rear end 20 of the vehicle 12 faces backwardly from the vehicle 12 relative to a user 22 who is driving the vehicle 12. Each of the left taillight 16 and the right taillight 18 are positioned on the rear end 20 of the vehicle 12 wherein each of the left taillight 16 and the right taillight 18 are configured to be visible to a driver who is following behind the vehicle 12.

A lever 24 is manipulatable to selectively actuate a blinking pattern for one of the left taillight 16 and the right taillight 18. The blinking pattern is configured to signal an intent of the user 22 of the vehicle 12 to turn in a respective one of a left direction and a right direction. The lever 24 is therefore generally coupled to a steering wheel 26 of the vehicle 12 wherein the lever 24 is configured to be accessible to the user 22 while the user 22 is driving the vehicle 12.

A processor 28 may be in communication with the lever 24. The processor 28 selectively actuates the blinking pattern for one of the left taillight 16 and the right taillight 18 when the lever 24 is manipulated. A dashboard 30 is positioned within the vehicle 12 and is typically adjacent to the lever 24 because he dashboard 30 is configured to be accessible to the user 22 while the user 22 is driving the vehicle 12.

An indicium 32 is coupled to the left taillight 16. More specifically, the indicium 32 is positioned within the left taillight 16. Generally, the right taillight 18 is free of the indicium 32. The indicium 32 may have a plurality of lights wherein the indicium 32 is configured for illumination within the left taillight 16 to visibly notify the driver following behind the vehicle 12 that the user 22 intends to make a U-turn. In other words, the indicium 32 may only be positioned on the left taillight 16, and may be absent from the right taillight 18, because U-turns typically require the user 22 to turn toward the left. Thus, positioning the indicium 32 only within the left taillight 16 clarifies to the driver following the vehicle 12 that the user 22 intends to make the U-turn toward the left. The indicium 32 may have a color that is different than a color of the left taillight 16 to facilitate visibility of the indicium 32 when the left taillight 16 is actuated.

The indicium 32 is generally selected from a group consisting of a broken line 34, a solid line 50, and a wording 62. The wording 62 is generally selected from the group consisting of “U TURN” and “U-TURN.”

The broken line 34 may include an upper member 36 that has an outer end 38. The upper member 36 extends from the outer end 38 toward the right taillight 18. A lower member 40 is vertically spaced from the upper member 36. The lower member 40 is generally parallel to the upper member 36. The lower member 40 may have a length that is less than a length of the upper member 36.

An arcuate member 42 extends between the upper member 36 and the lower member 40. The arcuate member 42 generally has an inner edge 44 and an outer edge 46. The inner edge 44 may be concavely arcuate between the upper member 36 and the lower member 40. The outer edge 46 may therefore be convexly arcuate between the upper member 36 and the lower member 40. The arcuate member 42 is positioned distally relative to the outer end 38 of the upper member 36 wherein the arcuate member 42 is positioned between the upper member 36 and the right taillight 18 and wherein the outer edge 46 of the arcuate member 42 faces toward the right taillight 18. An arrow 48 is coupled to the lower member 40. The arrow 48 points left wherein the arrow 48 points away from the right taillight 18 and wherein the arrow 48 is configured to visually indicate the user 22 intends to take the U-turn in the left direction. The arrow 48 may have a length that is equal to a difference between the length of the lower member 40 and the length of the upper member 36.

The solid line 50 may include a top segment 52 and a bottom segment 54 that is vertically spaced from the top segment 52. The bottom segment 54 may be parallel to the top segment 52. The bottom segment 54 may have a length that is equal to a length of the top segment 52. A middle segment 56 extends between the top segment 52 and the bottom segment 54. The middle segment 56 may have a left edge 58 and a right edge 60. The left edge 58 faces away from the right taillight 18. The right edge 60 faces toward the right taillight 18. The left edge 58 may be concavely arcuate between the top segment 52 and the bottom segment 54. The right edge 60 may be convexly arcuate between the top segment 52 and the bottom segment 54.

A toggle 64 is in communication with the processor 28 of the vehicle 12. Manipulation of the toggle 64 signals the processor 28 to illuminate the indicium 32 within the left taillight 16. The toggle 64 may be positioned on the dashboard 30 wherein the toggle 64 is configured for is accessible to the user 22 while the user 22 is driving the vehicle 12. In other embodiments, the toggle 64 may be positioned on the lever 24 wherein the toggle 64 is configured for is actuated by the user 22 when the user 22 manipulates the lever 24.

In use, the vehicle 12 may be driven as normal. When the user 22 is going to make a U-turn, the user 22 can press the brake 14, slowing or stopping the vehicle 12. The user 22 may manipulate the toggle 64, illuminating the indicium 32 within the left taillight 16 to signal that the user 22 intends to make the U-turn. The user 22 may also manipulate the lever 24 to actuate the blinking pattern for the left taillight 16. Thus, the user 22 can clearly and distinctly signal to the driver who is following the vehicle 12 that the user 22 specifically intends to make a U-turn, as opposed to a standard left turn.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A taillight system comprising:
a vehicle including:
a left taillight;
a right taillight; and
a rear end facing backwardly from the vehicle relative to a user, each of the left taillight and the right taillight being positioned on the rear end of the vehicle wherein each of the left taillight and the right taillight are configured to be visible to a driver who is following behind the vehicle;
a lever being manipulatable to selectively actuate a blinking pattern for one of the left taillight and the right taillight wherein the blinking pattern is configured to signal an intent of a user of the vehicle to turn in a respective one of a left direction and a right direction; and
a processor being in communication with the lever wherein the processor selectively actuates the blinking pattern for one of the left taillight and the right taillight when the lever is manipulated;
an indicium being coupled to the left taillight, the indicium being positioned within the left taillight, the indicium being configured for illumination within the left taillight to visibly notify the driver who is following behind the vehicle that the user intends to make a U-turn, the indicium being selected from a group consisting of:
a broken line;
a solid line; and
a wording;
a toggle being in communication with the processor of the vehicle wherein manipulation of the toggle signals the processor to illuminate the indicium within the left taillight.

2. The taillight system of claim 1, wherein the right taillight is free of the indicium.

3. The taillight system of claim 1, wherein the lever is coupled to a steering wheel of the vehicle wherein the lever is configured to be accessible to the user while the user is driving the vehicle.

4. The taillight system of claim 3, wherein the toggle is positioned on the lever wherein the toggle is configured for being actuated by the user when the user manipulates the lever.

5. The taillight system of claim 1, the vehicle further comprising a brake being actuatable to stop the vehicle, the left taillight being illuminated when the brake is actuated, the right taillight being illuminated when the brake is actuated.

6. The taillight system of claim 5, wherein the indicium has a color being different than a color of the left taillight to facilitate visibility of the indicium when the left taillight is actuated.

7. The taillight system of claim 1, the vehicle further comprising a dashboard being positioned within the vehicle adjacent to the lever wherein the dashboard is configured to be accessible to the user while the user is driving the vehicle.

8. The taillight system of claim 7, wherein the toggle is positioned on the dashboard wherein the toggle is configured for being accessible to the user while the user is driving the vehicle.

9. The taillight system of claim 1, the broken line further comprising:
an upper member having an outer end, the upper member extending from the outer end toward the right taillight;
a lower member being vertically spaced from the upper member;
an arcuate member extending between the upper member and the lower member, the arcuate member having an inner edge and an outer edge, the inner edge being concavely arcuate between the upper member and the lower member, the outer edge being convexly arcuate between the upper member and the lower member; and
an arrow being coupled to the lower member, the arrow pointing left wherein the arrow points away from the right taillight.

10. The taillight system of claim 9, wherein the lower member is parallel to the upper member.

11. The taillight system of claim 9, wherein the lower member has a length being less than a length of the upper member.

12. The taillight system of claim 11, wherein the arrow having a length being equal to a difference between the length of the lower member and the length of the upper member.

13. The taillight system of claim 9, wherein the arcuate member is positioned distally relative to the outer end of the upper member wherein the arcuate member is positioned between the upper member and the right taillight and wherein the outer edge of the arcuate member faces toward the right taillight.

14. The taillight system of claim 1, the solid line further comprising:
a top segment;
a bottom segment being vertically spaced from the top segment; and
a middle segment extending between the top segment and the bottom segment.

15. The taillight system of claim 14, wherein the bottom segment is parallel to the top segment.

16. The taillight system of claim 14, wherein the bottom segment has a length being equal to a length of the top segment.

17. The taillight system of claim 14, wherein the wording is selected from the group consisting of “U TURN” and “U-TURN.”

18. A taillight system comprising:
a vehicle including:
a brake being actuatable to stop the vehicle;
a left taillight being illuminated when the brake is actuated;
a right taillight being illuminated when the brake is actuated;
a rear end facing backwardly from the vehicle relative to a user who is driving the vehicle, each of the left taillight and the right taillight being positioned on the rear end of the vehicle wherein each of the left taillight and the right taillight are configured to be visible to a driver who is following behind the vehicle;
a lever being manipulatable to selectively actuate a blinking pattern for one of the left taillight and the right taillight wherein the blinking pattern is configured to signal an intent of the user to turn in a respective one of a left direction and a right direction, the lever being coupled to a steering wheel of the vehicle wherein the lever is configured to be accessible to the user while the user is driving the vehicle;
a processor being in communication with the lever wherein the processor selectively actuates the blinking pattern for one of the left taillight and the right taillight when the lever is manipulated; and
a dashboard being positioned within the vehicle adjacent to the lever wherein the dashboard is configured to be accessible to the user while the user is driving the vehicle;
an indicium being coupled to the left taillight, the indicium being positioned within the left taillight wherein the right taillight is free of the indicium, the indicium having a plurality of lights wherein the indicium is configured for illumination within the left taillight to visibly notify the driver following behind the vehicle that the user intends to make a U-turn, the indicium having a color being different than a color of the left taillight to facilitate visibility of the indicium when the left taillight is actuated, the indicium being selected from a group consisting of:
a broken line including:
an upper member having an outer end, the upper member extending from the outer end toward the right taillight;
a lower member being vertically spaced from the upper member, the lower member being parallel to the upper member, the lower member having a length being less than a length of the upper member;
an arcuate member extending between the upper member and the lower member, the arcuate member having an inner edge and an outer edge, the inner edge being concavely arcuate between the upper member and the lower member, the outer edge being convexly arcuate between the upper member and the lower member, the arcuate member being positioned distally relative to the outer end of the upper member wherein the arcuate member is positioned between the upper member and the right taillight and wherein the outer edge of the arcuate member faces toward the right taillight; and
an arrow being coupled to the lower member, the arrow pointing left wherein the arrow points away from the right taillight, the arrow having a length being equal to a difference between the length of the lower member and the length of the upper member;
a solid line including:
a top segment;
a bottom segment being vertically spaced from the top segment, the bottom segment being parallel to the top segment, the bottom segment having a length being equal to a length of the top segment; and
a middle segment extending between the top segment and the bottom segment, the middle segment having a left edge and a right edge, the left edge facing away from the right taillight, the right edge facing toward the right taillight, the left edge being concavely arcuate, the right edge being convexly arcuate; and
a wording, the wording being selected from the group consisting of “U TURN” and “U-TURN;” and
a toggle being in communication with the processor of the vehicle wherein manipulation of the toggle signals the processor to illuminate the indicium within the left taillight.

19. The taillight system of claim 18, wherein the toggle is positioned on the dashboard wherein the toggle is configured for being accessible to the user while the user is driving the vehicle.

20. The taillight system of claim 18, wherein the toggle is positioned on the lever wherein the toggle is configured for being actuated by the user when the user manipulates the lever.
